(19) United States
(12) Patent Application Publication
(10) Pub. No.: US 2006/0206847 A1
(43) Pub. Date: Sep. 14, 2006

(54) Layout optimizing method for a semiconductor device, manufacturing method of a photomask, a manufacturing method for a semiconductor device, and computer program product

(76) Inventor: Ryuji Ogawa, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/357,089

(22) Filed: Feb. 21, 2006

(30) Foreign Application Priority Data
Feb. 21, 2005 (JP) 2005-044256

(51) Int. Cl. G06F 17/50

(52) U.S. Cl. 716/9

(57) ABSTRACT

A layout optimizing method for a semiconductor includes preparing design rule of a semiconductor device, circuit connection information or layout data of the semiconductor device, and circuit characteristic information of the semiconductor device, and optimizing a layout of the semiconductor device using the design rule, the circuit connection information or the layout data, and the circuit characteristic information.

### CROSS-REFERENCE TO RELATED APPLICATIONS

This application is based upon and claims the benefit of priority from prior Japanese Patent Application No. 2005-044256, filed Feb. 21, 2005, the entire contents of which are incorporated herein by reference.

### BACKGROUND OF THE INVENTION

1. Field of the Invention

The present invention relates to a layout optimizing method for a semiconductor device which includes a semiconductor integrated circuit comprising MOS transistors, a liquid crystal panel comprising TFTs, or the like and to a manufacturing method for a photomask, a manufacturing method for a semiconductor device, and a computer program product.

2. Description of the Related Art

In recent years, the technical level and difficulty in semiconductor integrated circuit fabrication technology have increased, and it has become very difficult to enhance a yield (i.e. the ratio of the number of non-defective chips to the number of all chips per wafer). Under the circumstances, in order to enhance the yield, it is imperative to devise (optimize) design layout patterns.

A conventional layout optimizing method (tool) for semiconductor devices, for example, as shown in FIG. 7, optimizes a layout so as to minimize the layout area based on circuit connection information (or original layout GDS) and a design rule. Thereafter, it is determined whether the optimized layout satisfies a predetermined condition. If the predetermined condition is satisfied, the optimized layout is stored in a memory device as optimized layout GDS. If the optimized layout fails to satisfy the predetermined condition, the optimization of layout is repeated.

Further, there is known a layout optimizing method for a semiconductor device, wherein a pattern shape, which affects a yield, is defined in advance, and a pattern having such a pattern shape is changed (“Design and Yield Improvement” seminar, 9. Integrated Design and Process Yield Optimization Flows, PDF Solutions Sagantec, Nov. 13, 2001). In this method, all patterns having the above-mentioned pattern shape are changed. Then, among the patterns having the pattern shape, even the pattern that does not required to be changed is also changed. Such pattern change results only in area penalty.

Further, the conventional layout optimizing method for the semiconductor device has such a problem that it is difficult to realize desired circuit characteristic in the recent semiconductor devices with higher integration and finer miniaturization of circuit element. Since the progress in the integration and miniaturization will continue, it is expected that this problem will become more serious.

### BRIEF SUMMARY OF THE INVENTION

According to an aspect of the present invention, there is provided a layout optimizing method for a semiconductor comprising: preparing design rule of a semiconductor device, circuit connection information or layout data of the semiconductor device, and circuit characteristic information of the semiconductor device; and optimizing a layout of the semiconductor device using the design rule, the circuit connection information or the layout data, and the circuit characteristic information.

According to an aspect of the present invention, there is provided a method for manufacturing a photomask comprising: creating an optimized layout for a semiconductor device using a layout optimizing method for a semiconductor device according to an aspect of the present invention; preparing a mask blank including a transparent substrate and a light-shield film provided on the transparent substrate; applying a resist on the light-shield film; forming a resist pattern, the forming the resist pattern including irradiating light or a charge beam on the resist by an exposure apparatus based on the data of the optimized layout of the semiconductor device, and developing the resist on which the light or charge beam is irradiated; and etching the light-shield film using the resist pattern as a mask.

According to an aspect of the present invention, there is provided a method for manufacturing a semiconductor device comprising: applying a resist on a substrate including a semiconductor substrate; forming a resist pattern, the forming the resist pattern including disposing a photomask above the substrate, the photomask being manufactured by a method for manufacturing the photomask according to an aspect of the present invention, irradiating light or a charge beam on the resist via the photomask, and developing the resist on which the light or the charge beam is irradiated; and forming a pattern by etching the substrate using the resist pattern as a mask.

According to an aspect of the present invention, there is provided a computer program product configured to store program instructions for execution on a computer system enabling the computer system to perform: an instruction for inputting design rule of a semiconductor device, circuit connection information or layout data of the semiconductor device, and circuit characteristic information of the semiconductor device into the computer; and an instruction for optimizing a layout of the semiconductor device using the design rule, the circuit connection information or the layout data, and the circuit characteristic information.

### BRIEF DESCRIPTION OF THE SEVERAL VIEWS OF THE DRAWING

FIG. 1 is a flow chart illustrating a layout optimizing method for a semiconductor device according to a first embodiment of the present invention;

FIG. 2 is a flow chart illustrating a layout optimizing method for a semiconductor device according to a second embodiment of the present invention;

FIG. 3 is a flow chart illustrating a layout optimizing method for a semiconductor device according to a third embodiment of the present invention;

FIG. 4 is a flow chart illustrating a layout optimizing method for a semiconductor device according to a fourth embodiment of the present invention;

FIG. 5 is a flow chart illustrating a layout optimizing method for a semiconductor device according to a fifth embodiment of the present invention;

FIG. 6 is a flow chart illustrating a layout optimizing method for a semiconductor device according to a sixth embodiment of the present invention;

FIG. 7 is a flow chart illustrating a conventional layout optimizing method for a semiconductor device; and

FIG. 8 is a view for explaining a computer program product according to embodiment.

### DETAILED DESCRIPTION OF THE INVENTION

Embodiments of the present invention will now be described with reference to the accompanying drawings.

### FIRST EMBODIMENT

FIG. 1 is a flow chart illustrating a layout optimizing method for a semiconductor device according to a first embodiment of the present invention.

At first, there are prepared a memory unit 1 that stores design rule of a semiconductor device, a memory unit 2 that stores circuit connection information of the semiconductor device, and a memory unit 3 that stores circuit characteristic information of the semiconductor device.

Next, the design rule, circuit connection information and circuit characteristic information, which are read out of the memory units 1 to 3, are input to an optimizing unit such as a P & R (automatic place & route) tool, a migratory or a comparator tool, and the optimizing unit optimizes layout based on the circuit connection information, design rule and circuit connection information (step S1).

At this time, the layout is optimized so as to be obtain desired circuit connection characteristic and to be set the layout area at a predetermined value or less, that is, to minimize the layout area.

The circuit connection information includes information relating to information on connection of between circuits that constitute an integrated circuit of the semiconductor device.

The circuit characteristic information is information relating to attribute of location of change in the layout pattern of the semiconductor device, and the location affects the circuit characteristic by change of layout.

The change of the layout is associated with a pattern in the layout pattern, and means at least one of change of the position of the pattern (shift of the pattern), change of shape and change of dimensions.

The circuit characteristic include, for instance, pairing characteristic of transistor performance, the ratio in performance between transistors, device resistance or condition relating to circuit device shape. Specifically, the circuit characteristic is current driving characteristic and wiring delay characteristic of MOS transistor.

The information relating to attribute of location of change refers to information on degree/magnitude of the attribute of the location of change itself, information defined in association with the attribute, or both of these information items. For example, if the attribute of the location of change is a gate width, this information refers to the dimensions of the gate width (i.e. information on degree/magnitude of the attribute of the location of change itself), or a dispersion tolerance in dimensions of the gate width (i.e. information defined in association with the attribute).

Shown below are specific examples of circuit characteristic information and design rule items (indicated in parentheses ( )) which affect the circuit characteristic information, with respect to the transistor performance, parasitic capacitance and parasitic resistance. In this case, the transistor is a MOS transistor.

Transistor performance: current characteristic (gate length, gate width, gate-STI (Shallow Trench Isolation) distance).

Parasitic capacitance: gate capacitance (gate area), poly-Si wiring capacitance (distance between poly-Si wiring lines, area of poly-Si wiring area), and diffusion capacitance (diffusion area).

Parasitic resistance: poly-Si resistance (poly-Si wiring line width, poly-Si wiring line length), and diffusion sheet resistance (gate-contact distance, diffusion width, diffusion length).

Listed below are specific examples of circuit characteristic information and design rule items (indicated in parentheses ( )) which affect the circuit characteristic information, with respect to the pairing characteristics of transistor performance, the ratio in performance between transistors, and the device resistance.

Pairing characteristic: difference in dimensions of gate L/W of two MOS transistors, and environments (gate length, gate width, diffusion length, diffusion width, number of contacts, positions of contacts, directions of contacts).

Ratio in transistor performance: ratio in gate L between two MOS transistors, and ratio in gate W (gate length, gate width, diffusion length, diffusion width).

Device resistance: poly-Si resistance, well resistance, and MOS capacitor (device L/W value, device L/W ratio).

Next, it is determined whether the layout which is obtained in step S1 satisfies a predetermined condition or not (step S2).

If the condition is satisfied, the layout is stored in a memory unit 4 as optimized layout GDS. On the other hand, if the condition is not satisfied, steps S1 and S2 are repeated until the condition is satisfied.

According to the present embodiment, the circuit characteristic information is used in addition to the circuit connection information and design rule, and the layout is created and optimized so as to obtain desired circuit characteristic information and to minimize the layout area. Therefore, even if the degree of integration density and microfabrication of semiconductor integrated circuit progresses, it is possible to easily realize semiconductor devices having desired circuit characteristic information.

In addition, by replacing the item (or restrictive condition) that affects the circuit characteristic with layout related values which represent design shape, or dispersion tolerance values, it becomes possible to manage the presence/absence of an effect on circuit characteristic by the change of layout shape.

### SECOND EMBODIMENT

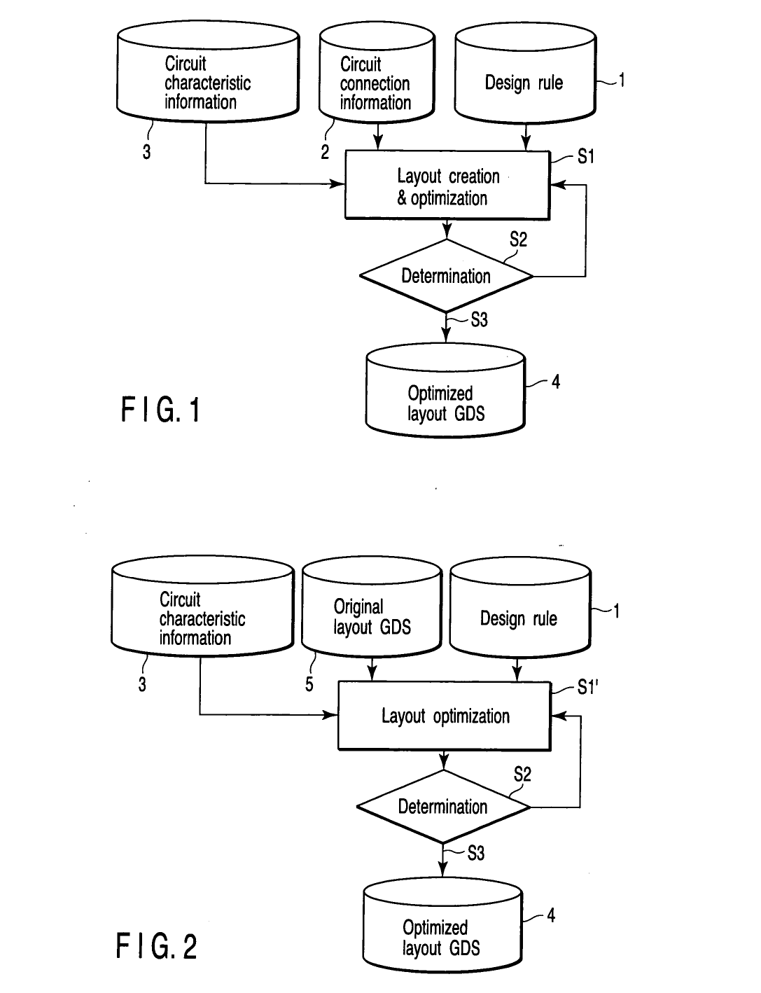

FIG. 2 is a flow chart illustrating a layout optimizing method for a semiconductor device according to a second embodiment of the present invention. As regards the Figures to be referred to below, common parts are denoted by like reference numerals, and a detailed description is omitted.

The second embodiment differs from the first embodiment in that the memory unit 2 which stores the circuit connection information is replaced with a memory unit 5 which stores original layout GDS (original design pattern data).

Layout is optimized based on the original layout GDS, design rule and circuit characteristic information so as to obtain desired circuit characteristic information and to minimize the layout area (step S1′).

It is determined whether the layout which is obtained in step S1′ satisfies the condition or not (step S2).

If the condition is satisfied, the layout is stored in the memory unit 4 as optimized layout GDS (step S3).

On the other hand, if the layout fails to satisfy the condition, steps S1′ and S2 are repeated until the condition is satisfied.

According to the present embodiment, the circuit characteristic information is used in addition to the original layout GDS and design rule, and the layout is optimized so as to obtain desired circuit characteristic information and to minimize the layout area. Therefore, even if the degree of integration density and microfabrication of semiconductor integrated circuit progresses, it is possible to easily realize semiconductor devices having desired characteristic.

### THIRD EMBODIMENT

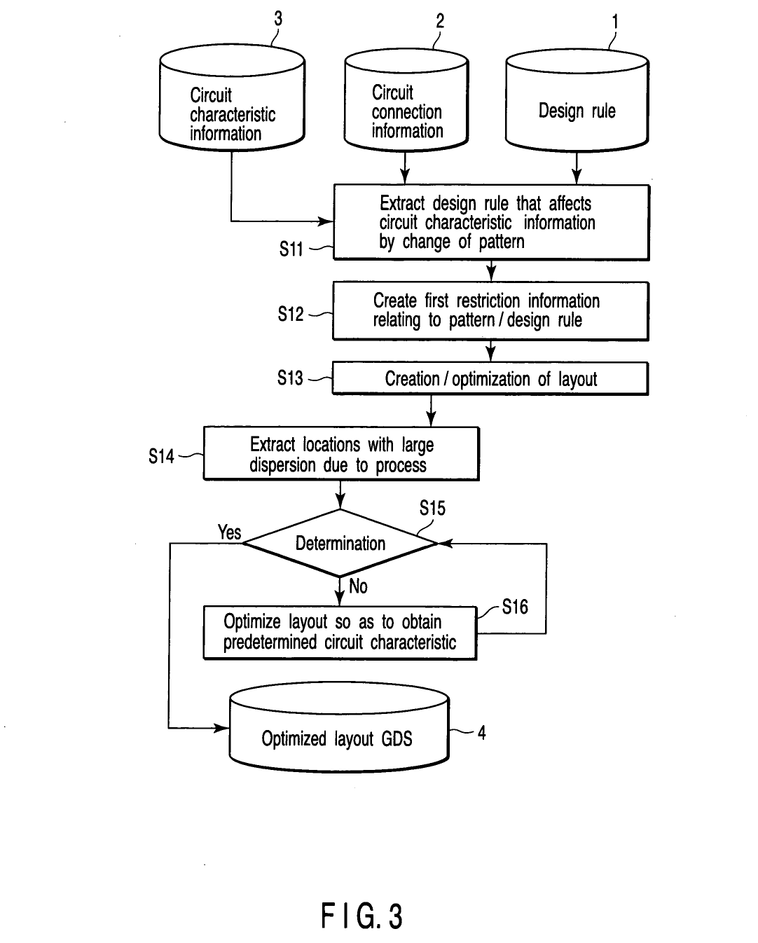

FIG. 3 is a flow chart illustrating a layout optimizing method for a semiconductor device according to a third embodiment of the present invention.

The present embodiment relates to a layout optimizing method for a semiconductor device in a case where original layout data (e.g. original layout GDS) is absent when a new cell is to be formed.

At first, when a pattern in the layout pattern of the semiconductor device is changed, based on the design rule of the semiconductor device, the circuit connection information and the circuit characteristic information, the design rule of the semiconductor device are classified into two categories, that is, design rule that affects the circuit characteristic information and design rule that does not affect the circuit characteristic information, and the design rule that affects the circuit characteristic information is extracted from the design rule of the semiconductor device (step S11).

The change of the pattern is, for example, shift of the pattern, change of pattern shape, or change of pattern dimensions. In the shift of the pattern, for example, one of two patterns is shifted so as to vary the distance between the two patterns. In the change of pattern shape, for example, the shape of the source/drain is changed while the source/drain area is being fixed. In the change of pattern dimensions, for example, the gate width or gate length is varied.

As the design rule that affects the circuit characteristic information, for example, in the case where the circuit characteristic information is the gate capacitance, the diffusion capacitance of the source/drain, the diffusion resistance of the source/drain, the poly-Si wiring resistance and the poly-Si inter-wiring capacitance, then, the gate width and gate length (which affect the gate capacitance), the source/drain width and source/drain length (which affect the diffusion capacitance/diffusion resistance), the poly-Si wiring line width (which affects the poly-Si wiring resistance), and the poly-Si inter-wiring distance (which affects the poly-Si inter-wiring capacitance) are given.

Next, the pattern, the design rule, or the information (first restriction information) relating to restriction (first restriction) for the pattern and design rule which are necessary to obtain desired circuit characteristic information for the change of pattern, the change of design rule or the change of the pattern and design rule is created based on the design rule extracted in step S11 and the circuit characteristic information (for instance, Tr. L dimensions, W dimensions, S/D area value, poly-Si wiring capacitance value, and poly-Si wiring resistance value (these are dimensional absolute value) and Tr. L dimensional dispersion ±Xnm, W dimensional dispersion ±Ynm, poly-Si wiring capacitance dispersion ±Z %, and poly Si wiring resistance value ±Z % (these are dispersion specifications) (step S12).

The change of pattern is, for example, change of a pattern area, change of a pattern position (pattern shift) or change of pattern dimensions. Specifically, in the change of pattern shape, the shape of the source/drain is changed while the source/drain area is being fixed. In the change of pattern dimensions, for example, changing the design rule into the greater dimensions than minimum dimensions is given.

The first restriction information is given by a combination of a dimensional absolute value and a dispersion tolerance value, or by a dispersion tolerance value. For example, if the first restriction information is restriction information relating to design rule, it is given by L±ΔX [nm] . L is a Tr. L dimensional value (dimensional absolute value). The value ±ΔX is a dispersion value (dispersion tolerance) of L, which can meet desired circuit characteristic. If the first restriction information is restriction information relating to the source/drain area, it is given by ±ΔS %. The value ±ΔS is a dispersion value (dispersion tolerance) of S, which can meet desired circuit characteristic and is expressed by percentage relative to the source/drain area S (fixed value).

By adopting the above-described steps S11 and S12, it becomes possible to clearly define the layout and design rule which must be considered, and accordingly it becomes possible to clearly define the boundary condition in layout design optimization.

Next, layout is created and optimized based on the first restriction information, circuit connection information, design rule and circuit characteristic information so as to obtain desired circuit characteristic and to set the layout area at a predetermined value or less, that is, to minimize the layout area (step S13).

When the layout is created and optimized in this manner, the first restriction information is considered. Thereby, the creation and optimization of the layout, in which the circuit characteristic information is considered, is executed, and it becomes possible to easily realize the layout of the semiconductor device having desired circuit characteristic.

Next, among the layout obtained in step S13, the location having a large dispersion due to the process is extracted by simulation (step S14).

In the simulation, the first restriction information obtained in step S12, the circuit connection information and the design rule or the like are used as data.

In general, it is highly possible that locations, such as a gate corner, a wiring terminal, a wiring corner portion, a narrow space and an isolated wiring line, are extracted as locations having the dispersion due to the process. As the dispersion, dispersion in dimensions and shape of a pattern is given. In addition, as the dispersion, dispersion in difference between a pattern (target) on a mask and a pattern on a wafer which corresponds to the pattern is given. The difference includes a dimensional difference, a shape difference and positional difference.

Next, it is determined whether the dispersion of the locations extracted in step S14 is such the great dispersion or not so as to make it impossible to obtain desired circuit characteristic based on the first restriction information created in step S12 (step S15).

If it is determined that the desired circuit characteristic cannot be obtained, the layout is optimized mainly with respect to the locations having the large dispersion extracted in step S15, thereby to obtain desired circuit characteristic (step S16). Thereafter, step S15 is performed again. Steps S15 and S16 are repeated until the condition is satisfied.

The layout which is determined to have desired circuit characteristic in step S15, is stored in the memory unit 4 as optimized layout GDS.

The present embodiment also obtains the same advantageous effect as in the first embodiment. Additionally, in the present embodiment, the optimization of the layout is executed further considering the dispersion due to the process, therefore, it is possible to more easily realize a semiconductor device having desired circuit characteristic information.

Furthermore, in the present embodiment, only the location having large dispersion due to the process is extracted by simulation in step S14, and the extracted locations having large dispersion is mainly corrected. Therefore, unlike the conventional method (“Design and Yield Improvement” seminar, 9. Integrated Design and Process Yield Optimization Flows, PDF Solutions Sagantec, Nov. 13, 2001) in which all patterns having pattern shapes that affect the yield are changed, the problem of area penalty can sufficiently be reduced.

### FOURTH EMBODIMENT

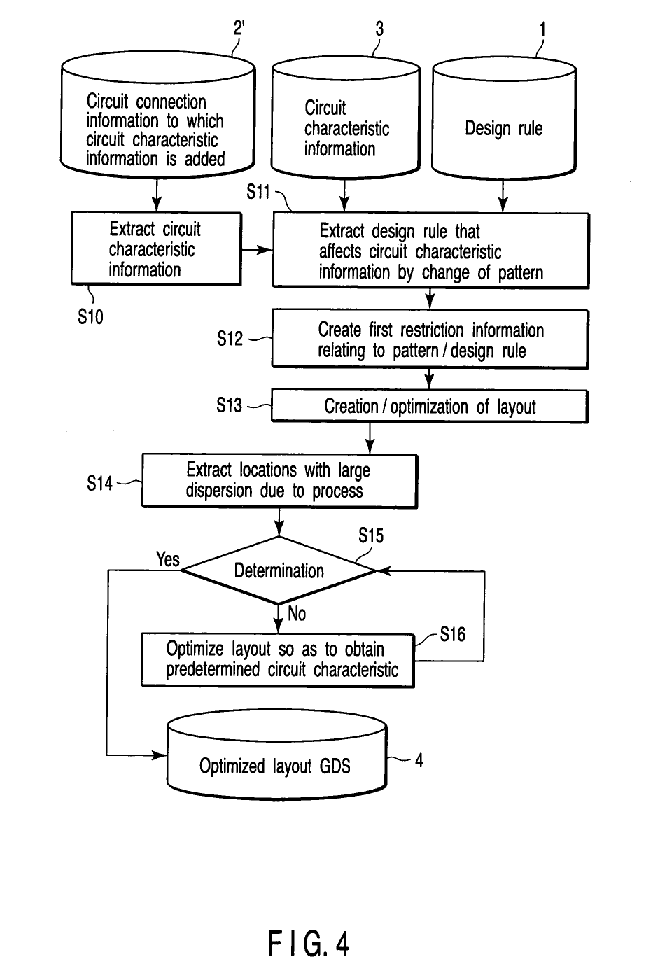

FIG. 4 is a flow chart illustrating a layout optimizing method for a semiconductor device according to a fourth embodiment of the present invention.

The present embodiment differs from the third embodiment in that the memory unit 2 which stores the circuit connection information is replaced with a memory unit 2′ that stores circuit connection information to which circuit characteristic information is added, the circuit characteristic information is extracted from the memory unit 2′ (step S10), and the extracted circuit characteristic information can be used in step S11.

The circuit characteristic information which is extracted in step S10, may be the same as, or different from, the circuit characteristic information stored in the memory unit 3.

If the circuit characteristic information extracted in step S10 is the same as the circuit characteristic information stored in the memory unit 3, one of them is used in step S11.

The case that two items of the circuit characteristic information are different is a case that the characteristic information which is different from the circuit characteristic information stored in the memory unit 3 is used.

According to the present invention, circuit characteristic information which is different from the circuit characteristic information stored in the memory unit 3 beforehand can be used suitably, thereby, a semiconductor device having desired characteristic can more easily be realized.

### FIFTH EMBODIMENT

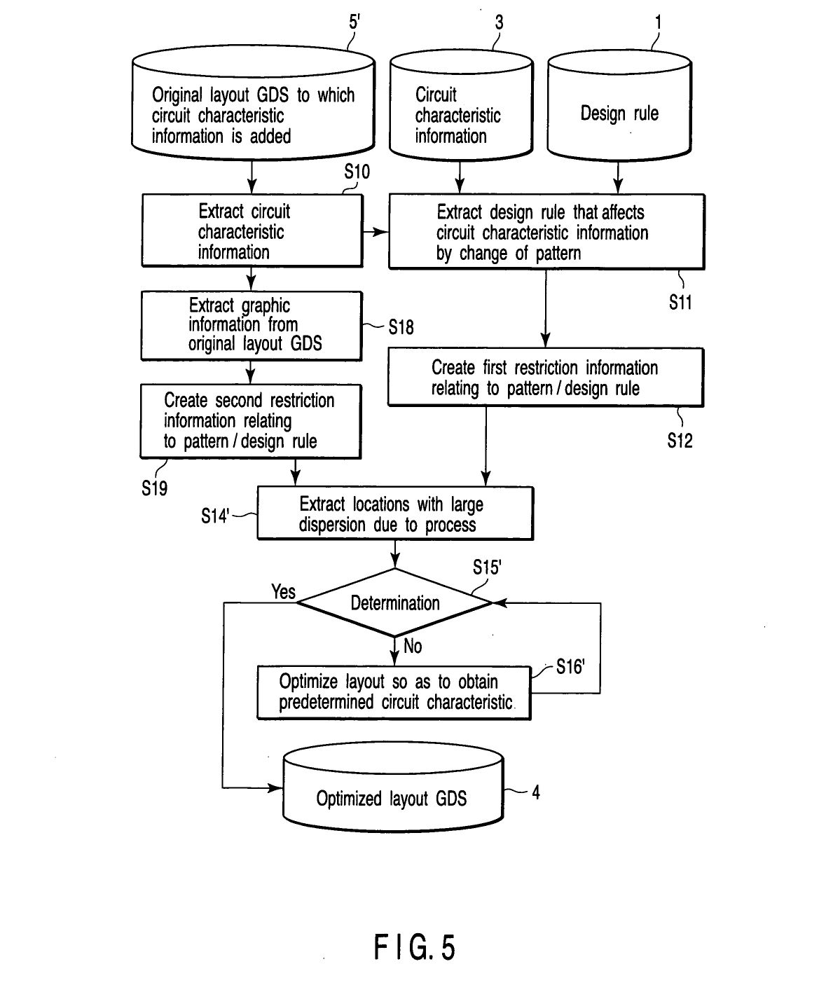

FIG. 5 is a flow chart illustrating a layout optimizing method for a semiconductor device according to a fifth embodiment of the present invention. The present embodiment relates to a layout optimizing method for a semiconductor device in a case where original layout GDS exists when a new cell is to be formed.

Circuit characteristic information is added to the original layout GDS, and the original layout GDS to which the circuit characteristic information is added is stored in a memory unit 5′.

A design rule L1 of the original layout GDS stored in the memory unit 5′ is not greater than a design rule L2 stored in the memory unit 1. A case in which L1 is greater than L2 (L1>L2) is, for example, a case in which the semiconductor device of the same layout is to be further reduced in size. A case of L1=L2 is, for example, a case in which the layout is re-optimized when a variation of circuit characteristic due to the process is large.

Like the third embodiment, step S11 is executed based on the original layout GDS, the design rule and the circuit characteristic information.

Here, the circuit characteristic information that is used in step S11 is that stored in the memory unit 3 or that extracted in step S10.

Next, the first restriction information is created based on the design rule extracted in step S11 and the circuit characteristic information used in step S11, (step S12).

On the other hand, graphic information (e.g. layer, width, interval, shape, position) of the layout pattern of the semiconductor device is extracted from the original layout GDS which is used in step S10, or from the original layout GDS which is read out of the memory unit 5′ once again (step S18).

Next, the graphic information that affects the circuit characteristic information is extracted from the graphic information of the layout pattern which is classified into two categories, that is, the design rule that affects the circuit characteristic information and the design rule that does not affect the circuit characteristic information when the pattern in the layout pattern of the semiconductor device is changed based on the original layout GDS, the design rule and the circuit characteristic information.

Next, the pattern, the design rule, or the information (second restriction information) relating to restriction (second restriction) for the pattern and design rule which are necessary to obtain desired circuit characteristic information for the change of pattern, the change of design rule or the change of the pattern and design rule is created based on the extracted graphic information and the circuit characteristic information (for instance, Tr. L dimensions, W dimensions, S/D area value, poly-Si wiring capacitance value, and poly-Si wiring resistance value (these are dimensional absolute value) and Tr. L dimensional dispersion ±Xnm, W dimensional dispersion ±Ynm, poly-Si wiring capacitance dispersion ±Z %, and poly Si wiring resistance value ±Z % (these are dispersion specifications) (step S19).

Next, only location in the original layout GDS, where process-induced non-uniformity is large, are extracted by simulation (step S14′).

In the simulation, the first and second restriction information, which is obtained in steps S12 and S19, the original layout GDS and the design rule are used.

Subsequently, based on the first and second restriction information that is created in step S12 and step S19, it is determined whether the non-uniformity at the locations, which are extracted in step S14′, are such great non-uniformity as to make it impossible to obtain desired circuit characteristic (step S15′).

If it is determined that the desired circuit characteristic cannot be obtained, the layout is optimized mainly with respect to the locations with high non-uniformity, which are extracted in step S15′, in consideration of the first and second restriction information, thereby to obtain desired circuit characteristic (step S16′). Then, step S15′ is repeated. Steps S15′ and S16′ are repeated until the condition is satisfied.

The layout determined to have desired circuit characteristic in step S15′ is stored in the memory unit 4 as optimized layout GDS.

Step S10 may be omitted, and it may be performed as in the third embodiment. In this case, the memory unit 5 is substituted for the memory unit 5′.

The present embodiment also obtains the same advantageous effect as in the fourth embodiment. Additionally, in the present embodiment, the optimization of the layout is executed further considering the dispersion due to the process, therefore, it is possible to more easily realize a semiconductor device having desired circuit characteristic information.

### SIXTH EMBODIMENT

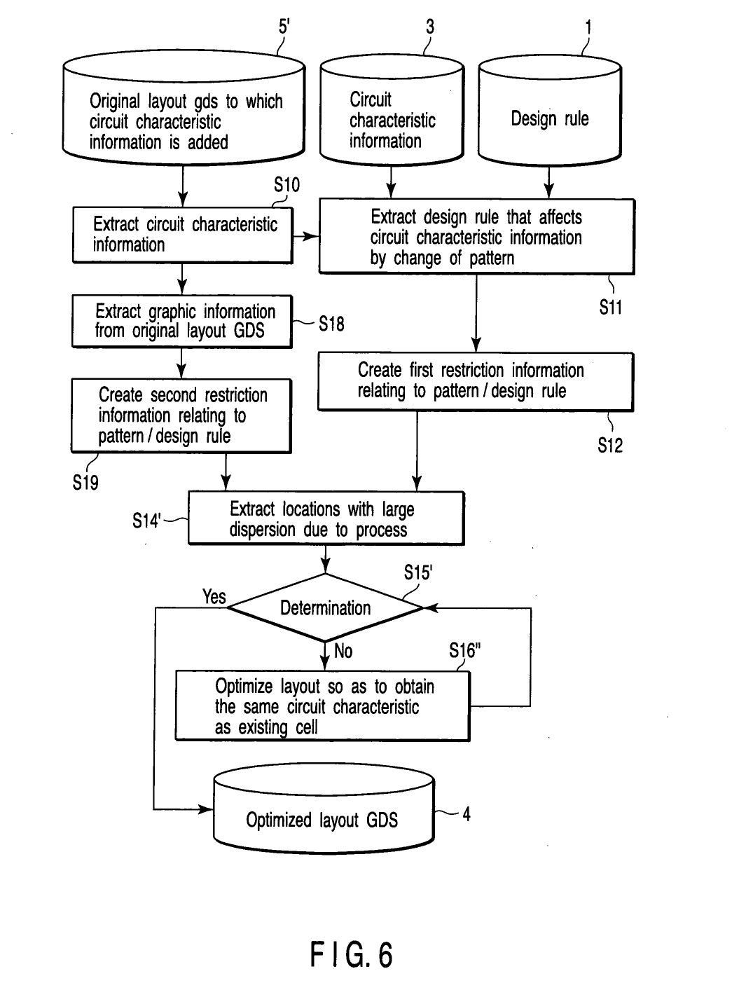

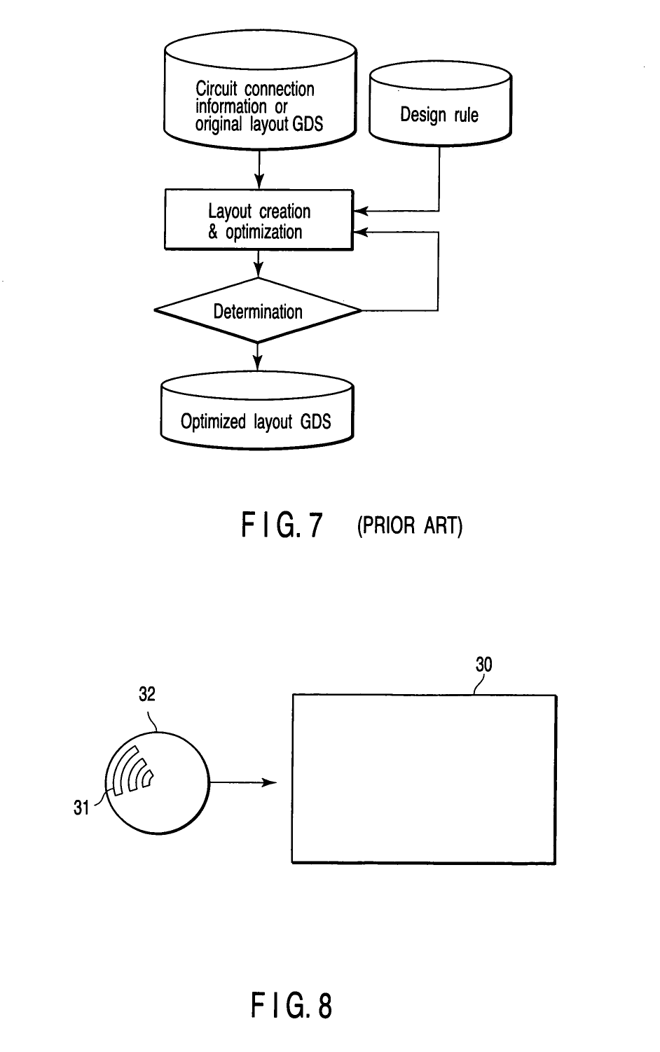

FIG. 6 is a flow chart illustrating a layout optimizing method for a semiconductor device according to a sixth embodiment of the present invention.

The present embodiment referrers to a layout optimizing method for a semiconductor device in a case where there is an existing cell and to form a cell which has the same circuit characteristic as the existing cell when the change of process of the existing cell is occurred.

The existing cell is, for example, an actual product. The change of the process of the existing cell is, for example, the change of process of the actual process for enhancing the yield. In the present embodiment, the design rule L i of the original layout GDS stored in the memory unit 5′ is the same as the design rule L2 stored in the memory unit 3.

In the present embodiment, instead of step S16′ (FIG. 5) in the fifth embodiment, the layout is optimized in a manner that the same circuit characteristic as the existing cell is obtained. In the other respects, the sixth embodiment is the same as the fifth embodiment. Further, step S10 may be omitted, and it may be performed as in the third embodiment.

### SEVENTH EMBODIMENT

Next, a method for manufacturing a photomask of the present embodiment is described.

At first, using any one of the layout optimizing methods for semiconductor devices according to the first to sixth embodiments, an optimized layout of the semiconductor device is created.

Next, a mask blank which comprises a transparent substrate and a light-shield film provided on the transparent substrate is prepared, thereafter, a resist is applied on the light-shield film.

Next, light or a charge beam (e.g. electron beam) is irradiated on the resist by exposure apparatus based on the data of the optimized layout of the semiconductor device, thereafter, the resist is developed, and a resist pattern is formed. The resist pattern has a layout which corresponds to the layout that is created using the layout optimizing method for the semiconductor device according to the embodiment.

At last, using the resist pattern as a mask, the light-shield film is etched, and a photomask is obtained.

### EIGHTH EMBODIMENT

Next, a method for manufacturing a semiconductor device according to the present embodiments is described.

At first, a resist is applied on a substrate including a semiconductor substrate. The semiconductor substrate is, for instance, a silicon substrate or an SOI substrate.

The photomask obtained by the manufacturing method for the seventh embodiment is disposed above the substrate, light or a charge beam is irradiated on the resist via the photomask, thereafter, the resist is developed, and a resist pattern is formed.

Next, using the resist pattern as a mask, the substrate is etched, and a fine pattern is formed.

Here, in the case where an underlayer of the resist (i.e. uppermost layer of the substrate) is a polycrystalline silicon film or a metal film, a fine electrode pattern or wiring pattern or the like is formed. In the case where the underlayer of the resist (i.e. uppermost layer of the substrate) is an insulating film, a fine contact hole pattern or a gate insulating film or the like is formed. In the case where the underlayer of the resist is the above-mentioned semiconductor substrate, a fine isolation trench (STI: shallow trench isolation) is formed.

According to the present embodiment, the photomask which is formed in consideration of the circuit characteristic is used, so that a semiconductor device with high integration density and fine structure having desired circuit characteristic can easily be manufactured.

As is shown in FIG. 8, the above-described methods of the embodiments can be realized as a computer program product (e.g. CD-ROM, DVD) 32 which stores a program 31 that is to be executed by a system including a computer 30.

For example, the computer program product of the layout optimizing method for the semiconductor device according to the embodiment is configured to cause the computer to execute the steps (instructions) of FIG. 1, the steps (instructions) of FIG. 2, the steps (instructions) of FIG. 3, the steps (instructions) of FIG. 4, the steps (instructions) of FIG. 5, or the steps (instructions) of FIG. 6.

The program is executed using hardware resources such as a CPU and a memory (an external memory may also be used) within the computer. The CPU reads in necessary data from the memory, and executes the steps (instructions) for the data. The result of each step (procedure) is temporarily stored in the memory on an as-needed basis, and the result is read out when it is needed in another step (instructions).

In the descriptions of the above-described embodiments, the semiconductor device including the semiconductor integrated circuit comprising MOS transistors, etc. is assumed. However, the present invention is also applicable to a semiconductor device including a liquid crystal panel composed of TFTs, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A layout optimizing method for a semiconductor device comprising:
preparing design rule of a semiconductor device, circuit connection information or layout data of the semiconductor device, and circuit characteristic information of the semiconductor device; and
optimizing a layout of the semiconductor device using the design rule, the circuit connection information or the layout data, and the circuit characteristic information.

2. The layout optimizing method according to claim 1, wherein in the optimizing the layout of the semiconductor device, the layout is optimized such that desired circuit characteristic is obtained and an area of the layout is set at a predetermined value or less.

3. The layout optimizing method according to claim 1, wherein the circuit connection information is information relating to a connection relationship between circuits to which circuit characteristic information is added.

4. The layout optimizing method according to claim 2, wherein the circuit connection information is information relating to a connection relationship between circuits to which circuit characteristic information is added.

5. The layout optimizing method according to claim 3, wherein in the preparing the design rule, the circuit connection information or the layout data, and the circuit characteristic information, the circuit characteristic information is extracted from the circuit connection information to which the circuit characteristic information is added.

6. The layout optimizing method according to claim 4, wherein in the preparing the design rule, the circuit connection information or the layout data, and the circuit characteristic information, the circuit characteristic information is extracted from the circuit connection information to which the circuit characteristic information is added.

7. The layout optimizing method according to claim 1, further comprising:
extracting a design rule which affects the circuit characteristic of the semiconductor device from the design rule of the semiconductor device in a case where a pattern in the layout pattern of the semiconductor device is changed based on the design rule, the circuit connection information or the layout data, and the circuit characteristic information; and
creating a first restriction information which is necessary for the circuit characteristic to meet desired characteristic based on the extracted design rule and the circuit characteristic information for at least one of change of the pattern in the layout pattern of the semiconductor and the design rule of the semiconductor device,
wherein in the optimizing the layout of the semiconductor device using the design rule, the circuit connection information or the layout data, and the circuit characteristic information, the layout of the semiconductor device is optimized by additionally using the first restriction information.

8. The layout optimizing method according to claim 2, further comprising:
extracting a design rule which affects the circuit characteristic of the semiconductor device from the design rule of the semiconductor device based on the design rule, the circuit connection information or the layout data, and the circuit characteristic information in a case where a pattern in the layout pattern of the semiconductor device is changed; and
creating a first restriction information which is necessary for the circuit characteristic to meet desired characteristic based on the extracted design rule and the circuit characteristic information for at least one of change of the pattern in the layout pattern of the semiconductor and the design rule of the semiconductor device,
wherein in the optimizing the layout of the semiconductor device using the design rule, the circuit connection information or the layout data, and the circuit characteristic information, the layout of the semiconductor device is optimized by additionally using the first restriction information.

9. The layout optimizing method according to claim 1, further comprising:
extracting graphic information of the layout pattern of the semiconductor device from the layout data;
extracting graphic information which affects the circuit characteristic information from the graphic information of the layout data in a case where a pattern in the layout pattern of the semiconductor device is changed based on the design rule, the layout data and the circuit characteristic information; and
creating a second restriction information which is necessary for the circuit characteristic to meet desired characteristic based on the extracted graphic information and the circuit characteristic information for at least one change of the pattern in the layout pattern of the semiconductor and the design rule of the semiconductor device,
wherein in the optimizing the layout of the semiconductor device using the design rule, the circuit connection information or the layout data, and the circuit characteristic information, the layout of the semiconductor device is optimized by additionally using the second restriction information.

10. The layout optimizing method according to claim 2, further comprising:
extracting graphic information of the layout pattern of the semiconductor device from the layout data;
extracting graphic information which affects the circuit characteristic information from the graphic information of the layout data in a case where a pattern in the layout pattern of the semiconductor device is changed based on the design rule, the layout data and the circuit characteristic information; and
creating a second restriction information which is necessary for the circuit characteristic to meet desired characteristic based on the extracted graphic information and the circuit characteristic information for at least one change of the pattern in the layout pattern of the semiconductor and the design rule of the semiconductor device,
wherein in the optimizing the layout of the semiconductor device using the design rule, the circuit connection information or the layout data, and the circuit characteristic information, the layout of the semiconductor device is optimized by additionally using the second restriction information.

11. The layout optimizing method according to claim 7, wherein in the optimizing the layout of the semiconductor device using the design rule, the circuit connection information or the layout data, and the circuit characteristic information, the layout of the semiconductor device is optimized so as to have same circuit characteristic as a semiconductor device including a preformed layout.

12. The layout optimizing method according to claim 9, wherein in the optimizing the layout of the semiconductor device using the design rule, the circuit connection information or the layout data, and the circuit characteristic information, the layout of the semiconductor device is optimized so as to have same circuit characteristic as a semiconductor device having a preformed layout.

13. The layout optimizing method according to claim 1, further comprising:
determining whether a layout which is obtained by the optimization of the layout of the semiconductor device satisfies a predetermined condition or not; and
repeating the optimization of the layout of the semiconductor device until the predetermined condition is satisfied in a case where the predetermined condition fails to be satisfied.

14. The layout optimizing method according to claim 2, wherein the circuit characteristic information is information relating to attribute of location of change in the layout pattern of the semiconductor device, the location affects the circuit characteristic when the layout of the semiconductor device is changed.

15. A method for manufacturing a photomask comprising:
creating an optimized layout for a semiconductor device using a layout optimizing method for a semiconductor device according to claim 1;
preparing a mask blank including a transparent substrate and a light-shield film provided on the transparent substrate;
applying a resist on the light-shield film;
forming a resist pattern, the forming the resist pattern including irradiating light or a charge beam on the resist by an exposure apparatus based on the data of the optimized layout of the semiconductor device, and developing the resist on which the light or charge beam is irradiated; and
etching the light-shield film using the resist pattern as a mask.

16. A method for manufacturing a photomask comprising:
creating an optimized layout of a semiconductor device using a layout optimizing method for a semiconductor device according to claim 2;
preparing a mask blank including a transparent substrate and a light-shield film provided on the transparent substrate;
applying a resist on the light-shield film;
forming a resist pattern, the forming the resist pattern including irradiating light or a charge beam on the resist by an exposure apparatus based on the data of the optimized layout of the semiconductor device, and developing the resist on which the light or charge beam is irradiated; and
etching the light-shield film using the resist pattern as a mask.

17. A method for manufacturing a semiconductor device comprising:
applying a resist on a substrate including a semiconductor substrate;
forming a resist pattern, the forming the resist pattern including disposing a photomask above the substrate, the photomask being manufactured by a method for manufacturing the photomask according to claim 15, irradiating light or a charge beam on the resist via the photomask, and developing the resist on which the light or the charge beam is irradiated; and
forming a pattern by etching the substrate using the resist pattern as a mask.

18. A method for manufacturing a semiconductor device comprising:
applying a resist on a substrate including a semiconductor substrate;
forming a resist pattern, the forming the resist pattern including disposing a photomask above the substrate, the photomask being manufactured by a method for manufacturing a photomask according to claim 16, irradiating light or a charge beam on the resist via the photomask, and developing the resist on which the light or the charge beam is irradiated; and
forming a pattern by etching the substrate using the resist pattern as a mask.

19. A computer program product configured to store program instructions for execution on a computer system enabling the computer system to perform:
an instruction for inputting design rule of a semiconductor device, circuit connection information or layout data of the semiconductor device, and circuit characteristic information of the semiconductor device into the computer; and
an instruction for optimizing a layout of the semiconductor device using the design rule, the circuit connection information or the layout data, and the circuit characteristic information.
